(19) United States
(12) Patent Application Publication
(10) Pub. No.: US 2003/0000778 A1
(43) Pub. Date: Jan. 2, 2003

(54) Drive system for multiple elevator cars in a single shaft

(76) Inventors: Rory Smith, El Cajon, CA (US); Robert H. Sweet, Lakeside, CA (US)

Correspondence Address: WHITE & CASE LLP, PATENT DEPARTMENT, 1155 AVENUE OF THE AMERICAS, NEW YORK, NY, 10036, US

(21) Appl. No.: 10/172,386

(22) Filed: Jun. 14, 2002

Related U.S. Application Data
(60) Provisional application No. 60/298,685, filed on Jun. 14, 2001.

(30) Foreign Application Priority Data
Jun. 14, 2002 (WO) PCT/US02/19006

(51) Int. Cl. B66B 1/06; B66B 1/00

(52) U.S. Cl. 187/902; 187/289

(57) ABSTRACT

The present invention is directed to an elevator system and method of controlling the speed of a linear motor driven elevator car to provide a means for operating multiple elevator cars in a single elevator shaft.

### BACKGROUND OF THE INVENTION

1. Field of the Invention

The present invention relates to a linear motor drive for raising and lowering elevator cars. In particular, the present invention provides for the independent operation of multiple elevator cars operating in a single elevator shaft.

2.Description of Related Art

Conventional elevator systems typically employ hoisting ropes or hydraulic pistons and cylinders as a hoisting means. In a roped system, one end of the hoist rope is connected to the top of an elevator car. The rope passes over a drive sheave, which is powered by a conventional rotating motor, and the other end of the rope is connected to a counterweight. In general, this arrangement does not allow more than one car to operate in one elevator shaft. Likewise, hydraulic elevator systems are limited to one car per shaft.

These conventional elevator systems have certain drawbacks. First, they require a great deal of otherwise useable building space. It has been estimated that approximately thirty percent of a the total space of a typical 100 story building is taken up by conventional elevators, shafts, halls, and machine rooms. Thus, it would be advantageous to reduce the number of elevator shafts without reducing the number of elevator cars available for passenger travel.

Second, conventional roped or hydraulic elevator systems have a limited travel height. Hydraulic elevators are generally limited to about 6 stories. Roped elevator systems are limited to about 1980 feet because above that length, the hoist rope can no longer support its own weight.

### SUMMARY OF THE INVENTION

The present invention allows multiple elevator cars to operate at different speeds and directions in a single elevator shaft. A linear motor primary element is installed in the shaft, usually in conjunction with elevator guide rails. The primary element is electrically connected to a source of substantially constant frequency alternating current (“AC”). A plurality of elevator cars reside and operate in the shaft. Each car has a variable speed linear motor drive apparatus affixed to it. The variable speed linear motor drive apparatus comprises linear motor secondary element that is electromagnetically coupled with the linear motor primary element. The linear motor secondary element is electrically connected in series with a run contact and a linear motor control apparatus. The linear motor control apparatus comprises a resistor and an electronic speed controller, such as a silicon triac based solid state speed controller, electrically connected in parallel with each other to form a control apparatus.

Because elevator car speed and direction is a function of the current flow through the linear motor secondary element, the present invention also provides a method for independently controlling the speed of each of a plurality of elevator cars operating in an elevator shaft. The method comprises closing the run contact, which because of the resistor allows minimal current to flow through the coil of the secondary element. In one embodiment, the control device is then pulse width modulated to cause current to flow through the control device. In another embodiment, speed may be controlled by varying the resistance of the resistor.

### BRIEF DESCRIPTION OF THE DRAWINGS

FIG. 1 illustrates a multicar elevator shaft employing a linear motor drive apparatus.

FIG. 2 is a schematic illustrating a linear motor drive apparatus and a linear motor primary element.

### DETAILED DESCRIPTION OF THE INVENTION

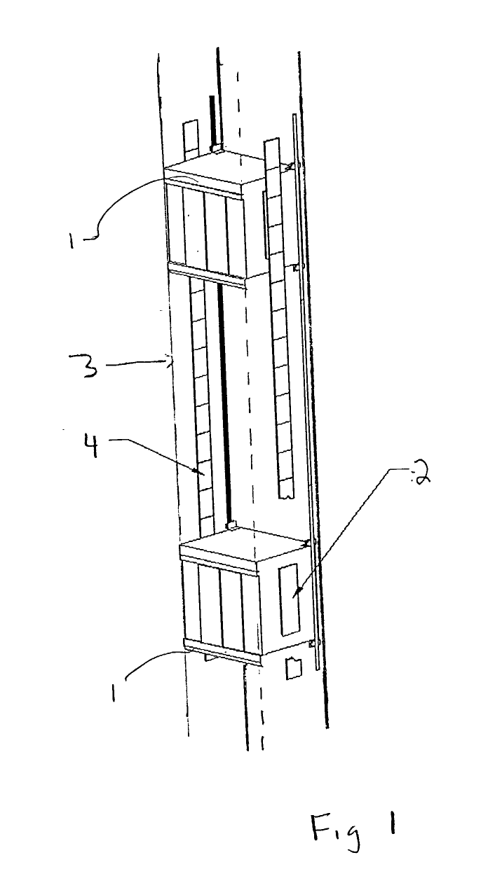

As shown in FIG. 1, a plurality of elevator cars 1 operating in a single elevator shaft 3 may be outfitted with a variable speed linear drive motor apparatus. The linear motor primary element 4 is mounted in the elevator shaft 3, typically along elevator guide rails, and is electrically connected to a source of substantially constant frequency alternating current electric power. Typically, the electric power will be three phase electric power. However, in some situations single phase power will be adequate.

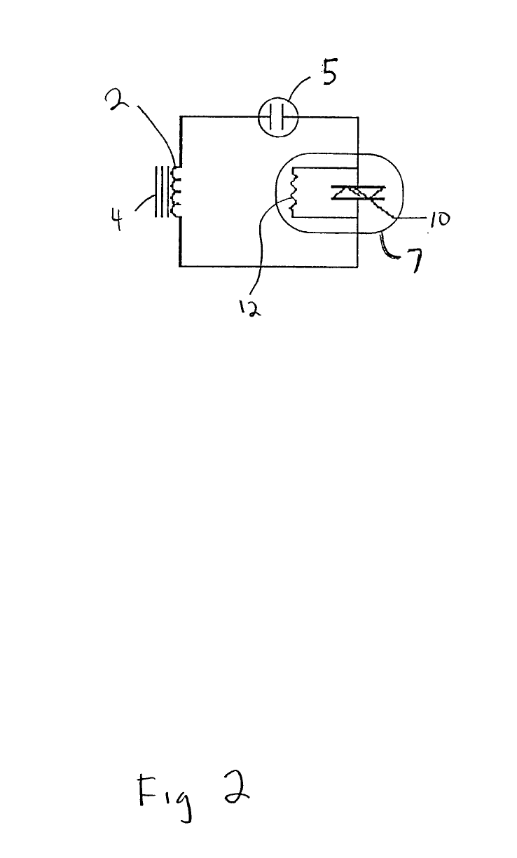

As shown in FIG. 2, the linear drive motor apparatus comprises a linear motor secondary element 2. The linear motor secondary element 2, is electromagnetically coupled with a linear motor primary element 4. The primary element 4 is the linear motor counterpart to the stator in a rotary motor and the secondary element 2 is the counterpart to the rotor. The linear motor secondary element 2 may be a wound coil type secondary element, or it may contain both permanent magnets and coils. The linear motor secondary element 2 is connected in series with a run contact 5 and a linear motor control apparatus 7. The linear control apparatus 7 comprises an electronic speed controller 10 that is suitable for use in controlling inductive loads, such as for example a silicon triac based speed controller, and a resistor 12 that are electrically connected in parallel with each other.

In operation, the run contact 5 is closed. The resistor 12 allows only minimal current to flow through the linear motor secondary element 2. One of the functions of the resistor 12 is to control transient voltages associated with opening an inductive circuit, such as the one formed by the secondary element 2 in FIG. 1. Current flow through the secondary element 2 is a function of the percentage of time that the speed controller 10 is in a conducting mode. One method of controlling the speed controller 10 is through pulse width modulation (“PWM”). In this method, current flow is a function of pulse width. Another method of controlling current flow through the linear motor secondary element 2 is to vary the resistance of the resistor 12. The speed and direction of the elevator car is directly related to the current flow through the secondary element 2.

In any elevator system, gravity plays an important role. When an elevator car is moving upward, kinetic energy is converted to potential energy. When an elevator car is moving downward, potential energy is converted to kinetic energy. If mechanical brakes are used to control the speed of a downward moving car, the kinetic energy is converted to heat, which is not recoverable. In the elevator system of the claimed invention which employs linear drive motors, it is possible to convert the kinetic energy from a downward moving car into electrical energy. The linear motor acts as a generator when the elevator car is traveling downward and the generated electric power can either be stored or returned to a power supplier.

Since the above described elevator system allows an elevator car to control its own speed independently and without the need to vary the frequency or voltage in the linear motor primary element, multiple cars can operate in a single shaft. In order to avoid collisions between elevator cars, the cars must be capable of horizontal movement. Elevator cars should also be capable of allowing passengers or cargo to be loaded and unloaded when the car is outside of the shaft. Once loaded, the car is transported to the shaft and connected to rails. In the case of elevator cars that must pass each other, one car can slow down, move horizontally, and permit the other car to pass it. The passed car is then returned to the shaft and resumes its vertical movement.

In another embodiment of the present invention, the elevator system contains an up shaft for upward moving cars and a down shaft for downward moving cars. When a car reaches the top or bottom of the shaft it travels horizontally to the other shaft.

What is claimed is:

1. An elevator system comprising:
an elevator shaft;
a linear motor primary element mounted in the shaft;
a source of substantially constant frequency alternating current electrically connected to the linear motor primary element;
a plurality of cars residing in the shaft;
a variable speed elevator car linear drive motor apparatus mounted to each car, the variable speed elevator car linear drive motor apparatus comprising:
a linear motor secondary element affixed to each car, the secondary element electromagnetically coupled with the primary element;
a run contract electrically connected in series with the secondary element; and
a linear motor control apparatus wired in series with the secondary element and the run contact, the linear motor control apparatus comprising:
(i) an electronic speed control device; and
(ii) a resistor electrically connected in parallel with the speed control device.

2. The elevator system of claim 1, wherein the resistor is a variable resistor.

3. The elevator system of claims 1 or 2, wherein the speed control device comprises a triac.

4. The elevator system of claim 3, wherein the speed control device is a pulse width modulation controlled device.

5. The elevator system of claim 1, wherein the source of alternating current is capable of absorbing regenerated current from the linear motor primary element.

6. A variable speed elevator car linear motor drive apparatus for use in an elevator shaft containing a linear motor primary element, the primary element connected to a source of substantially constant frequency alternating current, the variable speed elevator car linear motor drive apparatus comprising:
a linear motor secondary element affixed to an elevator car;
a run contact electrically connected in series with the secondary element; and
a linear motor control apparatus wired in series with the secondary element and the run contract, the linear motor control apparatus comprising:
(i) an electronic speed controller; and
(ii) a resistor electrically connected in parallel with the speed control device.

7. The apparatus of claim 6, wherein the resistor is a variable resistor.

8. The apparatus of claims 6 or 7, wherein the speed controller comprises a triac.

9. The apparatus of claim 8, wherein the speed controller is a pulse width modulation controlled device.

10. A method of controlling the speed of a linear motor driven elevator car having a linear motor secondary element having resistor connected in series with it, the secondary element affixed to the car and electromagnetically coupled with a linear motor primary element that is mounted in an elevator shaft, the method comprising:
inducing a current in the secondary element; and
varying the resistance of the resistor.

11. A method of controlling the speed of a linear motor driven elevator car having a linear motor secondary element mounted thereon, the secondary element being wired in series with a circuit containing a speed controller wired in parallel with a resistor, the method comprising:
inducing a flowing current in the secondary element; and
modulating the flowing current in the secondary element.

12. The method of claim 11, wherein the modulating of the flowing current is accomplished by pulse width modulation of the speed controller.
